(19) United States
(12) Patent Application Publication
(10) Pub. No.: US 2002/0190691 A1
(43) Pub. Date: Dec. 19, 2002

(54) Mobile phone emergency charger

(76) Inventor: Chen-Kuang Chen, Yungho City (TW)

Correspondence Address: JACOBSON HOLMAN PLLC, 400 SEVENTH STREET N.W., SUITE 600, WASHINGTON, DC, 20004, US

(21) Appl. No.: 09/883,778

(22) Filed: Jun. 19, 2001

(51) Int. Cl. H02J 7/00

(52) U.S. Cl. 320/114

(57) ABSTRACT

A mobile phone emergency charger comprising a shell housing internally having a battery module and a charging unit. The charging unit lifts the voltage of the battery module to charge the out of power mobile phone batteries.

### BACKGROUND OF THE INVENTION

I. Field of the Invention

This invention relates generally to a mobile phone emergency charger and, more specifically, to a mobile phone emergency charger that charges the out of power batteries of mobile phones.

II. Description of the Prior Art

Heretofore, it is known that with the telecommunication technology in progress in a very rapid pace, it is very convenient and easy to contact the desired person with mobile phone, especially under emergency situation. Therefore mobile phones benefit modern busy people, now almost everybody has a mobile phone.

Mobile phone gradually becomes one of the necessities of daily life, however mobile phone must be powered by batteries of certain brand, those batteries must be recharged when they are out of power. While outdoors, if batteries are out of power, it is not only very difficult to reach AC power but also take a long time to recharge those batteries. Therefore out of power batteries might cause those mobile phone users inconvenience and trouble.

### SUMMARY OF THE INVENTION

It is therefore a primary object of the invention to provide a mobile phone emergency charger that can recharge the out of power batteries of the mobile phones.

In order to achieve the objective set forth, a mobile phone emergency charger in accordance with the present invention comprises a shell housing internally having a battery module and a charging unit. The charging unit lifts the voltage of the battery module to charge the out of power mobile phone batteries.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a circuit diagram of an embodiment of the circuit diagram of the present invention;

FIG. 3 is an schematic diagram of the present invention when being used with mobile phone;

FIG. 4 is a block diagram of the present invention when being used with mobile phone;

FIG. 5 is a perspective view of a further embodiment of the present invention.

### DESCRIPTION OF THE PREFERRED EMBODIMENT

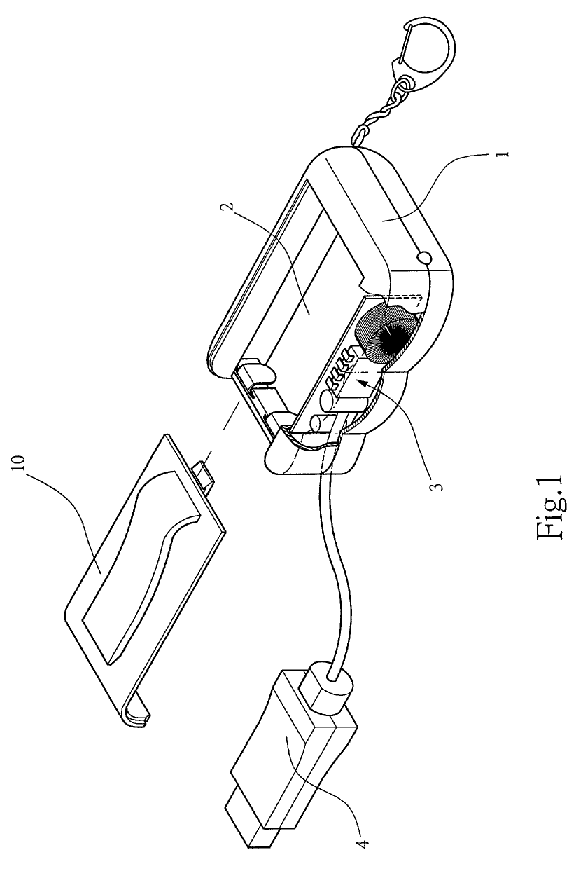

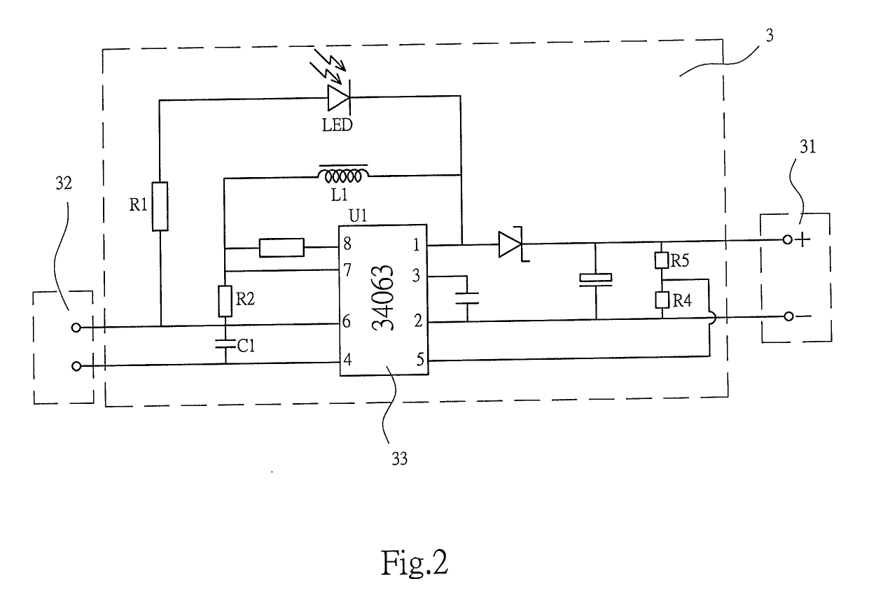

Referring to FIG. 1 and FIG. 2, the present invention is composed of a shell housing 1, which contains internally a battery module 2 and a charging unit. The functions of each component are described below:

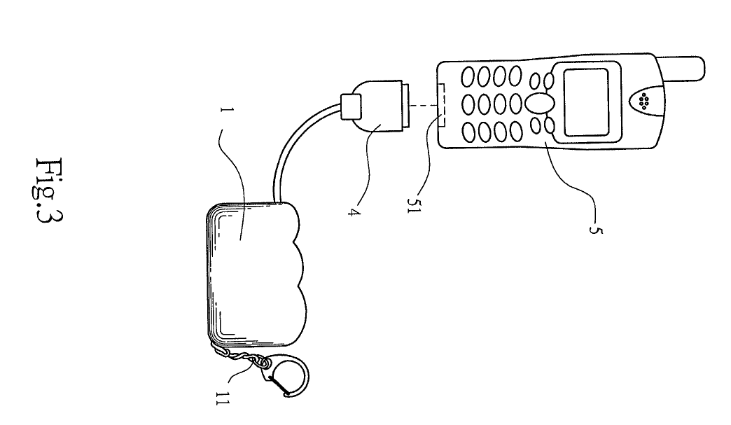

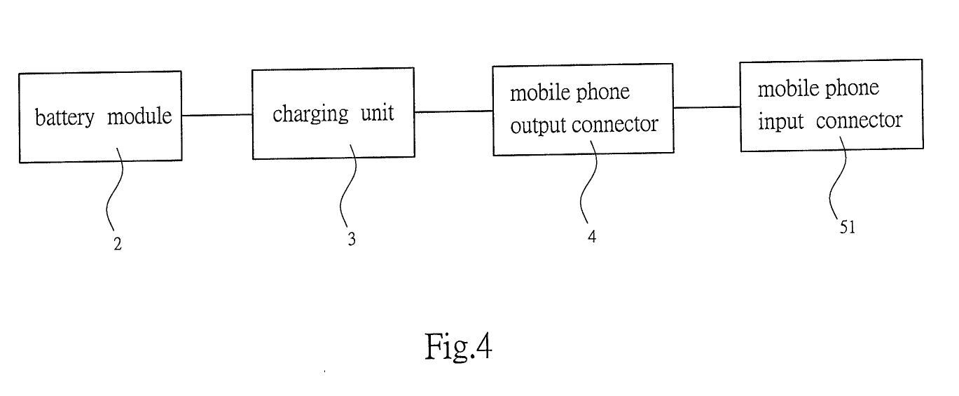

The shell housing 1 is in a carry-able size to move around with mobile phone users. The battery module 2 is inside of the shell housing 1. The charging unit 3 is also inside the shell housing 1. The charging unit 3 has an input connector 31 and an output end 32, the input connector 31 connects to the battery module 2, and output end 32 connects to a mobile phone output connector 4, as shown in FIG. 3 and FIG. 4. The mobile phone output connector 4 connects to the mobile phone input connector 51. The charging unit 3 also has a voltage lift IC 33 to lift the voltage level to recharge the batteries of the mobile phone 5.

Based on above description, a user can put batteries that can be bought in general grocery stores into the battery module 2, and then connects the mobile phone output connector 4 of the shell housing 1 to the mobile phone input connector 51 of the mobile phone 5. The voltage lift IC 33 of the charging unit 3 lifts the voltage level of the battery module to the recharge level of the mobile phone 5 to charge the batteries of the mobile phone 5. Therefore while the mobile phone 5 users are outdoors without AC power, the present invention can solve the charging problem.

The battery module 2 and the charging unit can accommodate into the shell housing 1, and the shell housing 1 is in carry-able size, therefore users can carry it around for emergency recharging.

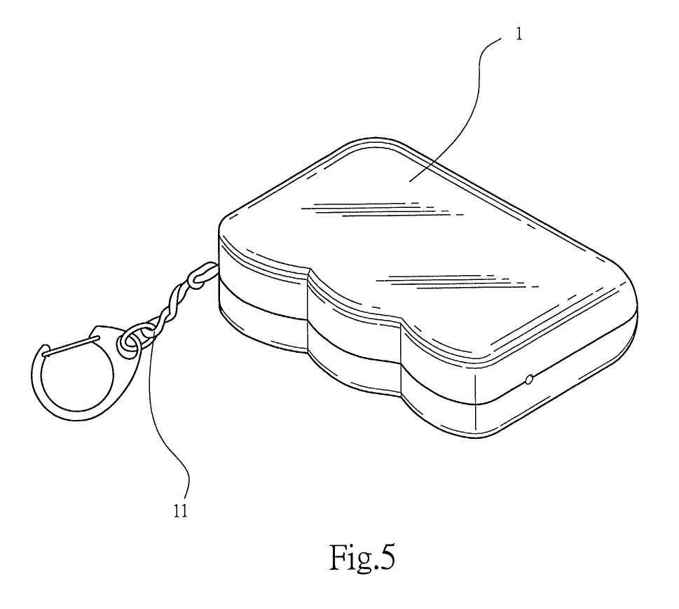

The battery module 2 will work together with batteries and the mobile phone output connector 4 together, while not using, the phone output connector 4 is inside the shell housing 1, as shown in FIG. 5, without exposure and damaged. The mobile phone output connector 4 can be pulled out through a track (not shown in FIG) from the shell housing 1 for recharging, while the battery module 2 can load batteries. When finish charging, the battery power of the battery module 2 is transferred to the mobile phone, the batteries of the battery module 2 are useless and moved out. The mobile phone output connector 4 can be paced back to the shell housing 1 to achieve the hidden and protective functions and easy to carry.

The present invention offers different mobile phone output connector 4 (not shown in FIG) to charge different batteries for different brands of mobile phones for more flexibility. Therefore it needs only to change the mobile phone output connector 4 for multiple mobile phones that save manufacturing cost.

The housing 1 further includes a cover 10 enclosing the battery module 2. In addition, the cover 10 includes a hook 11 adapted to attach the housing 1 to a belt of a user (not shown). Accordingly, the mobile phone 5 can be conveniently charged by the housing 1 when both are attached to the belt of the user.

While a preferred embodiment of the invention has been shown and described in detail, it will be readily understood and appreciated that numerous omissions, changes and additions may be made without departing from the spirit and scope of the invention.

What is claimed is:

1. A mobile phone emergency charger comprising:
a shell housing in a carry-able size;
a battery module inside of the said shell housing;
a charging unit inside the shell housing, said charging unit compromising an input connector and an output end, said input connector connects to said battery module;
a mobile phone output connector being connected to said output end, said mobile phone output connector connects to the mobile phone input connector;
a voltage lift IC lifting the voltage level of said battery module to recharge the batteries of the mobile phone.

2. A mobile phone charger, comprising:
a housing defining a cell apartment receiving battery therein;
a printed circuit board received in said housing and carrying circuitry for converting a voltage supplied from said cell apartment;
a cable assembly having a cable electrically connected to said circuitry of said printed circuit board, and a connector attached at a distant end of said cable and adapted to be electrically mated a connector of a mobile phone; and
a cover enclosing said cell apartment.

3. The mobile phone charger as recited in claim 1, wherein said cable assembly is received in said cell apartment when battery is not installed therein.

4. The mobile phone charger as recited in claim 1, wherein said cover includes a hook for attaching said housing to a belt of a user.

5. A mobile phone system, comprising:
a mobile phone adapted to be attached to a belt of a user;
a power supply unit attached to said belt and adjacent to said mobile phone, said power supply unit including a cable assembly electrically connected to said mobile phone for powering said mobile phone.
